(19) United States
(12) Patent Application Publication
(10) Pub. No.: US 2011/0320259 A1
(43) Pub. Date: Dec. 29, 2011

(54) LOCATION BASED ADVERTISING SYSTEM AND METHOD

(75) Inventors: Tasos Roumeliotis, Orinda, CA (US); Scott Hotes, Berkeley, CA (US); Andrew Talbot, Berkeley, CA (US); Daniel Hodges, San Francisco, CA (US)

(73) Assignee: WAVEMARKET, INC., Emeryville, CA (US)

(21) Appl. No.: 12/857,888

(22) Filed: Aug. 17, 2010

Related U.S. Application Data
(60) Provisional application No. 61/358,876, filed on Jun. 25, 2010.

(51) Int. Cl. G06Q 30/00; G06F 17/00

(52) U.S. Cl. 705/14.41; 705/14.58; 235/375

(57) ABSTRACT

A computer-implemented location based advertising method is provided. The method includes receiving advertising information and an indication of a physical location associated with the advertising information. The advertising information is transmitted to a first client associated with a first user. Entrance to the physical location is detected by either the first user or a mobile device associated with the first user. The transmission of the advertising information and the detection of the entrance to the physical location of the first user or the mobile device are reported to a second client associated with a second user. The present invention further provides a location based advertising systems.

### CROSS REFERENCE TO RELATED APPLICATION(S)

This application claims the benefit of U.S. provisional application No. 61/358,876, filed Jun. 25, 2010, which is incorporated by reference as if fully set forth.

### BACKGROUND

Location based marketing uses a consumer's geographic location to determine the content and type of advertisements presented to them. As a newer marketing discipline, few metrics and reporting systems exist to help companies understand the return on investment (“ROI”) of their location based marketing investment.

Internet marketers tend to rely on two key metrics: impressions and clickthroughs. Impressions are a gross measure of exposure to an advertisement by a target audience, usually a simple count of the number of times an advertisement is displayed. Clickthroughs are a counting of unique users who click on a hyperlink presented by an advertisement. The total clickthroughs divided by the total impressions is the advertisement's clickthrough rate, a number that can be compared across advertisements and campaigns to understand the effectiveness of a marketing effort. Clickthroughs can also be used for billing purposes, whereby an advertiser can be billed per clickthough instead of or in addition to per impression.

It would be desirable to provide a system to produce and report similar metrics for location based marketing as those currently used by internet marketers. It would be desirable to provide a system to deliver location based advertising and measure the effectiveness of such advertising for reporting and billing purposes.

### SUMMARY

The invention provides a computer-implemented location based advertising method. The method includes receiving advertising information and an indication of a physical location associated with the advertising information. The advertising information is transmitted to a first client associated with a first user. Entrance to the physical location is detected by either the first user or a mobile device associated with the first user after the transmission of the advertising information. The transmission of the advertising information and the detection of the entrance to the physical location of the first user or the mobile device are reported to a second client associated with a second user.

The invention further provides a location based advertising system comprising at least one computing device including at least one memory comprising instructions operable to enable the computing device to perform a procedure including transmitting advertising information as an impression to a mobile device associated with a first user. The procedure further includes detecting entrance of the mobile device associated with the first user to a physical location associated with the advertising information, and reporting to a client system associated with a second user the transmission of the advertising information and the detection of the entrance of the mobile device to the physical location.

The invention further provides non-transitory computer-readable media tangibly embodying a program of instructions executable by a computing device to implement a method, the computing device being capable of interfacing with a communications network. The method includes transmitting advertising information as an impression to a mobile device associated with a first user. The method further includes detecting entrance of the mobile device to a physical location associated with the advertising information, and reporting to a client system associated with a second user the transmission of the advertising information and the detection of the entrance of the mobile device to the physical location. As stated herein, non-transitory computer-readable media comprises all computer-readable media except for a transitory, propagating signal.

The invention further provides a computer-implemented advertising method including receiving advertising information associated with one or more physical locations. Advertising information is transmitted to a plurality of users, a portion of which correspond to location-trackable user accounts. Entrance of at least one of the plurality of users which corresponds to a location-trackable user account to the one or more physical locations is detected. An estimate is generated of the number of the plurality of users which enter the one or more physical locations based on the number of the plurality of users, the number of the plurality of users which correspond to location-trackable user accounts, and the number of the plurality of users which correspond to location-trackable user accounts which are detected as having entered the one or more physical locations. The generated estimate is reported.

The invention further provides a computer-implemented advertising method including receiving advertising information associated with one or more physical locations. A number of a plurality of users to enter the one or more physical locations before transmitting the advertising information to the plurality of users is determined. The advertising information is transmitted to the plurality of users. A number of the plurality of users to enter the one or more physical locations after transmitting the advertising information is determined. A difference is determined between the number of the plurality of users to enter the one or more physical locations after transmitting the advertising information and the number of the plurality of users to enter the one or more physical locations prior to transmitting the advertising information. The determined difference is reported.

The invention further provides a computer-implemented advertising method including receiving advertising information comprising an indication of a physical advertisement area, wherein the physical advertisement area comprises a physical advertisement to be exposed to a user. An indication of a physical location associated with the advertisement area is received. Entrance of a first user or a mobile device associated with the first user to the advertisement area is detected. Entrance of a first user or a mobile device associated with the first user to the physical location is detected. Detection of the entrance of the first user or the mobile device associated with the first user to the advertisement area and the physical location is reported to a second user.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIGS. 1-3 are schematic illustrations of exemplary operating environments in which a location based advertising system is operable according to a preferred embodiment of the present invention.

FIGS. 4-6 are flow charts showing computer-implemented advertising methods according to preferred embodiments of the invention.

FIG. 7 is a plan view of an example city streetscape in which the preferred location based advertising system of FIG. 1 is implemented.

FIG. 8 is a plan view of the interior of an example shopping establishment in which the preferred location based advertising system of FIG. 1 is implemented.

### DETAILED DESCRIPTION OF THE PREFERRED EMBODIMENT(S)

The preferred embodiments of the present invention are described below with reference to the drawing figures where like numerals represent like elements throughout.

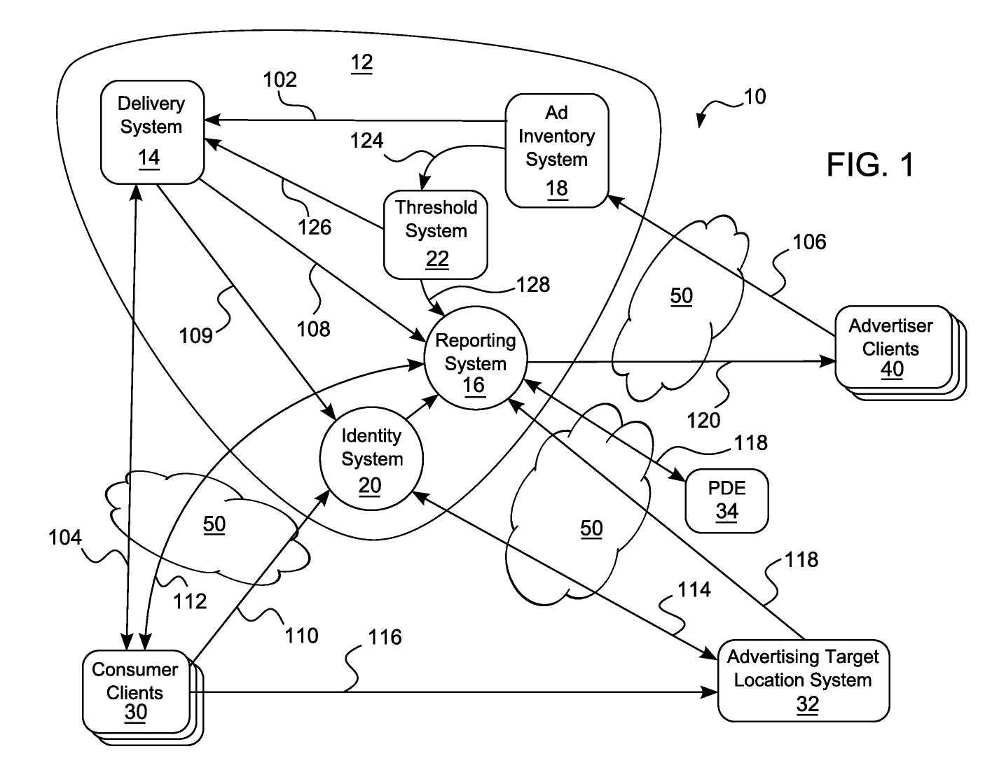

Referring to FIG. 1, a schematic illustration is shown of an exemplary operating environment 10 in which systems according to a preferred embodiment of the invention, including a location based advertising system 12, are shown. Communication flows are represented by arrows between the preferred systems and associated subsystems. The location based advertising system 12 and other components in the exemplary operating environment 10 preferably each include one or more computing devices and one or more memory devices, which computing devices and memory devices may be integrally constructed or connected in any suitable manner, for example via a network. The location based advertising system 12 preferably includes a plurality of subsystems including an impression delivery system 14, a reporting system 16, an advertisement inventory system 18, a central identity service system 20, and a threshold determination system 22, which subsystems 14, 16, 18, 20, 22 can be integrally configured or connected in any suitable manner, and which can be hardware enabled or software enabled to perform functions required of the location based advertising system 12.

The delivery system 14 preferably includes an application program interface (“API”) to retrieve advertising impressions in a communication 102 from a central advertising store or inventory managed via the advertisement inventory system 18 and to deliver advertising impressions to targeted users, also referred to herein as advertisees. The advertisement inventory system 18 contains and manages art, copy and specific offers that constitute advertisements which are preferably delivered by the impression delivery system 14 in the form of an impression to consumer clients 30 in a communication 104 via a network 50. As described herein, a consumer client 30 is preferably a telecommunication network enabled mobile device such as a mobile telephone or other wireless communication device. Alternatively, the consumer client 30 can include any suitable computing device configured to communicate via a wired or wireless network.

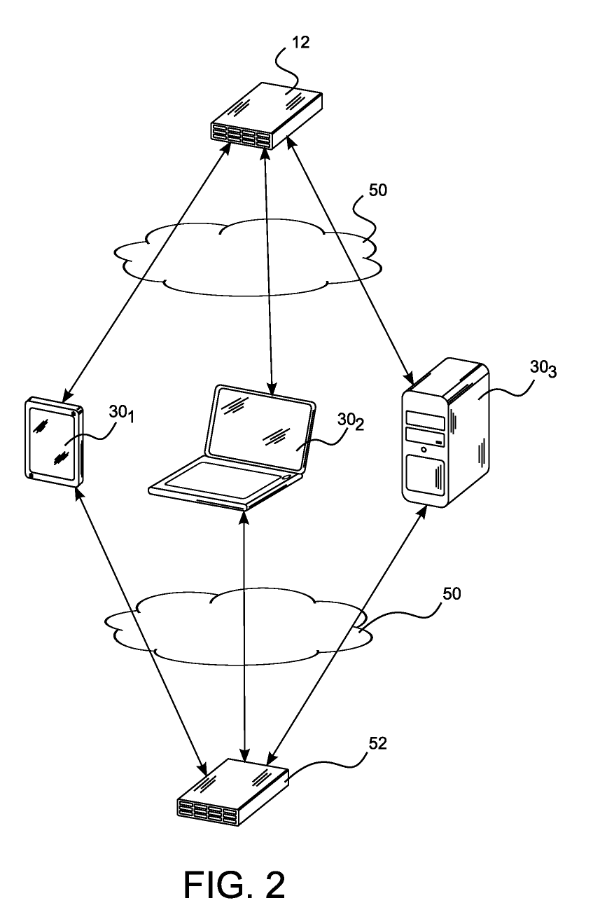

Advertisees are preferably associated with user accounts permitting the advertising system 12 to identify and authenticate an advertisee based on such user account regardless of what consumer client 30 an advertisee is using. Referring to FIG. 2, one advertisee corresponding to a particular user account can communicate with the advertising system 12 via multiple consumer clients, such as a mobile telephone consumer client 30₁, a laptop computer 30₂, and a stationary desktop computer 30₃. User accounts can be supported, updated and maintained across the multiple consumer clients 30₁, 30₂, 30₃ via the advertising system 12, or alternatively, via a remote application server 52 through the network 50. The remote application server 52 can further host and support applications which use impressions transmitted by the advertising system 12 to the consumer clients 30₁, 30₂, 30₃ via the network 50.

The advertisement inventory system 18 is preferably configured to receive advertisement constituents from an advertiser or other entity via an advertiser client 40 in a communication 106 via the network 50. Advertiser clients 40, as described herein, can include any suitable computing system or device configured to communicate via a wired or wireless network, operated by an entity wanting to provide marketing, promotional or advertising content to a consumer or other entity. Preferably, stored metadata associated with the advertisement constituents indicate cost rate limits associated with advertisements, physical target locations such as store locations associated with advertisements, key demographics to whom delivery of advertisements are preferred or non-preferred, target regions for delivery of advertisements and other information necessary to assemble a location targeted advertising campaign as described herein. The advertisement constituents received from the advertiser client 40 include at least advertising information and an indication of a physical target location associated with the advertising information. The advertising system 12 can be configured to deliver via the impression delivery system 14, commercial content such as advertisements for particular products or services, or non-commercial content such as public service messages. As described herein, an advertisement can be commercial or non-commercial and can include any suitable marketing, promotional or advertising content.

The delivery system 14 preferably measures a successful advertisement impression to a consumer client 30 when delivery results in no obvious communication error. The delivery system 14 reports delivery attempts to the reporting system 16 in a communication 108. Reports from the delivery system 14 can include one or more indicators of a user's engagement with a delivered advertisement. For instance, an SMS including a hyperlink can record a traditional style of clickthrough when a receiving user clicks on or otherwise activates the hyperlink via the consumer client 30, wherein notification of the interaction is detected by the delivery system 14.

The delivery system 14 delivers impressions until enough impressions have been successfully provided to meet a total price, total number of impressions, total impressions within a certain period of time, total expected ROI or other criteria provided by a marketer or advertiser via the advertiser client 40 or implemented by the delivery system 14. The delivery system 14 provides impressions across any suitable communications medium to the consumer client 30. Having received an impression, in a communication 110 the consumer client 30 preferably returns information to the advertising system 12 via the central identity service system 20, to indicate device configuration, device location, impression handling preferences or other information available regarding device identity or preferences.

The impression delivered to the consumer client 30 via the delivery system 14 can include extra offers, incentives or rewards, for instance a coupon code or digital badge, retainable by the user of the consumer client 30. The delivery system 14 can, optionally, report impression attempts and successes to the central identity service system 20 in a communication 109. The identity service system 20 preferably stores information connecting the delivered impression to a representation of a unique advertisee or consumer client 30 used by the advertisee. The identity service system 20 is preferably further configured to receive authorization from an advertisee via a consumer client 30 to transmit impressions and receive location information regarding a mobile device associated with a particular advertisee.

After delivering an impression, the advertising system 12 preferably establishes via the threshold determination system 22 one or more thresholds of physical distance around an advertiser's provided physical target location associated with the impression, which threshold acts as a metaphorical fence around the target location. Alternatively, the advertising system 12 can establish the one or more thresholds at any time after receiving advertising constituents including a physical target location. The advertisement constituents received by the advertising system 12 from an advertiser client 40 via the advertisement inventory system 18 preferably include the physical target location in the form of an address or geographic coordinate associated with advertising material to be transmitted as an impression to a consumer client 30. The threshold is preferably defined by one or more predetermined distances from a provided address or set of geographic coordinates. Thresholds determined by the threshold system 22 based on physical target location data received in a communication 124 are preferably forwarded to the delivery system 14 in a communication 126 for delivery with an impression and/or to the reporting system 16 in a communication 128.

In a preferred embodiment of the invention, the consumer client 30 is a mobile device configured for detecting its own location via suitable methods. Suitable non-limiting methods for location determination based on signal measurement include but are not limited to: Angle of Arrival (“AOA”), in which the angles of arrival of signals from two base stations (“base stations”) of known position are determined; Time Difference of Arrival (“TDOA”) or Time of Arrival (“TOA”), in which lengths of time it takes to receive signals from three or more base stations of known position are determined; Enhanced Observed Time Difference (“EOTD”), in which lengths of time it takes to receive signals from three or more base stations of known position are determined based on timing data provided via the network; Advanced Forward Link Trilateration (“AFLT”), in which the device position is triangulated based on signal measurements from three or more base stations of known position by determining phase differences of the signals and signal strengths; and signal strength triangulation, in which the device position is triangulated based on signal strength measurements from three or more base stations of known position, wherein in some implementations of signal strength triangulation multipath fingerprinting is incorporated to characterize received signals. Timing Advance (“TA”) values provided by a base station of known position to a mobile device can also provide the basis for calculation of a current location by triangulation or other suitable method. Alternatively, any suitable measurement of signals received by or transmitted from a mobile device from or to a base station or other system can be used as the basis for calculation of a current location. The mobile device consumer client 30 can also be configured to receive GPS signals from GPS satellites to determine location in a known manner via the received GPS signals and predetermined ephemeris and almanac data. Alternatively, an external position determining entity (“PDE”) 34 within the network 50 can be queried (communication 113) for current mobile device consumer client 30 location information, or the advertising system 12 can compute an estimated mobile device location based on signal measurements received from the mobile device consumer client 30 or the PDE 34.

When the advertisee breaches the defined threshold by physically moving into a defined threshold area, the breach is recorded by the advertising system 12 via the reporting system 16. In a preferred implementation in which threshold information or other information for determining a breach is transmitted to the consumer client 30 configured as a location aware mobile device, a breach can be detected via a location reporting client operating on the consumer client 30, and a report of the breach can be communicated as communication 112 to the reporting system 16. Alternatively, the advertising system 12 can periodically query a mobile device consumer client 30, PDE 34, or other network resource for the current location of the mobile device consumer client 30 to detect entrance to the defined threshold area. Alternatively, a sensor system with detection equipment monitoring the threshold of the physical target location can be employed to detect a threshold breach, which sensor system is preferably located at or in proximity to the physical target location in the form of an advertising target location system 32. In such alternative case, the advertising target location system 32 receives in a communication 114 from the advertising system 12 data for identifying the advertisee or associated consumer client 30, and thereafter receives via the sensor system in a communication 116 a suitable indication from a mobile device consumer client 30 to trigger detection of the breach, which indication preferably includes a radio signal. The advertising target location system 32 can alternatively include a system for detecting an advertisee's presence at a physical target location by reading and validating retained impression information, for instance reading and validating machine readable coding in the form of an electronic or paper coupon at the physical target location. Breaches detected by the advertising target location system 32 are preferably communicated as a breach report in a communication 118 to the reporting system 16 of the advertising system 12. Alternatively, other suitable systems can be provided for detecting a breach of a threshold or entrance to a physical target location and transmitting an associated indication of such breach or entrance to the advertising system 12. Consent of the advertisee in the form of a transmitted authorization is preferably required prior to detecting location of the advertisee or entrance to a threshold area, which authorization is preferably received by the advertising system 12 from a consumer client 30.

When a mobile device consumer client 30 detects entrance into a threshold area corresponding to a transmitted advertisement impression, the mobile device consumer client 30 preferably transmits a threshold breach report in a communication 112, along with useful identifying information, to the advertising system 12 via the reporting system 16 in a communication 112. The impression transmitted with the delivery system 14 in the communication 104 preferably includes an indication of a predetermined time limit within which the mobile device consumer client 30 must breach a threshold to trigger the transmission of a breach report by the mobile device consumer client 30 to the reporting system 16. Alternatively, the mobile device consumer client 30 can provide periodic location updates to the advertising system 12, which advertising system 12 via the reporting system 16 can determine whether the threshold has been breached. The location updates can be provided continuously or periodically for a predetermined period of time after receipt of the impression. Alternatively, if breach of the threshold is detected by a detection system at an advertiser's physical target location, the advertising target location system 32 transmits a threshold breach report along with available identifying information to the advertising system 12 respectively via the reporting system 16 and identity system 20 in communications 114, 118. As in the case when a consumer client 30 transmits a breach report, the advertiser detection system preferably must detect a breach by the mobile device consumer client 30 within a predetermined period of time to trigger transmission of a breach report by the advertising target location system 32. The indication of a predetermined time limit can correspond to an expiration time of a particular advertisement or promotion in a particular impression which the consumer client 30 relates to an advertisee via a user interface, wherein the advertisee must arrive at the particular physical location or partake of a particular promotion at the physical location before the expiration time occurs to receive a benefit.

The reporting system 16 aggregates the threshold breach information, associates breach information with impressions delivered by the delivery system 14, and provides a report or reporting mechanism to an advertiser or other entity using an advertiser client 40 in a communication 120. The reporting system 16 is preferably configured to determine a period of time after a particular impression is transmitted to a consumer client 30 that a threshold breach of a physical target location associated with the impression occurs, which information is transmitted to an advertiser client 40 to facilitate determining marketing effectiveness of the particular impression. Accordingly, advertisers can gauge the effectiveness of an advertising campaign to see if an impression delivered via the campaign results in an advertisee entering a retail store, restaurant or other advertiser physical target location, as determined by the threshold breach. In the case where a consumer client 30 or advertising target location system 32 delivers location information regarding the consumer client 30 to the reporting system 16 continually, without regard to any time limit imposed after the delivery of an impression, it is preferred that the reporting system 16 only report to a particular advertiser a threshold breach when such breach occurs within a predetermined period of time after delivery of an impression corresponding to a physical target location bound by the threshold. The reporting system 16 preferably enables billing of a particular advertiser based on a number of advertisement impressions delivered. The reporting system 16 can further enable billing of a particular advertiser based on threshold breaches associated with a particular impression, wherein an advertiser is billed based on the number of threshold breaches associated with impressions delivered in addition to or instead of based on the number of impressions delivered.

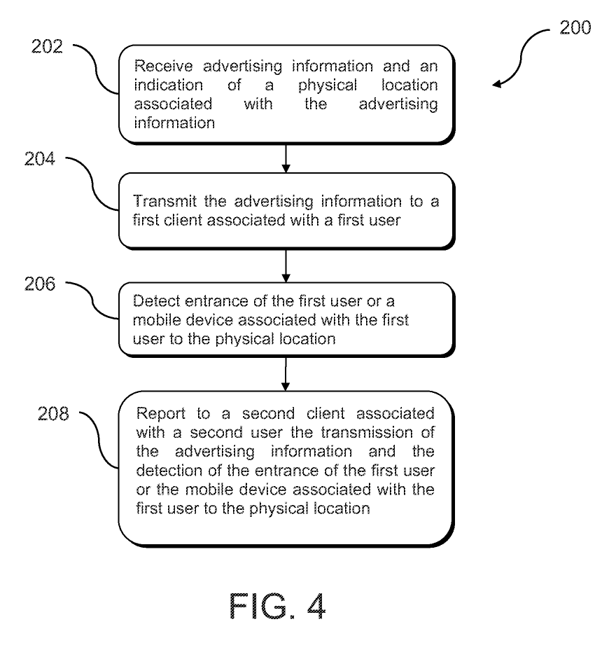

Referring to FIG. 4, a computer-implemented location based advertising method 200 is shown according to a preferred embodiment of the invention. The method 200 is described with reference to the preferred components shown in the operating environment 10 of FIG. 1, wherein the advertising system 12 preferably includes memory suitable for storing instructions for performance of the method 200. The method 200 may alternatively be performed via other suitable system or systems. The method 200 includes receiving advertising information and an indication of a physical location associated with the advertising information (step 202), such as from a client associated with an advertiser or other entity involved in the promotion of products, services or events. The advertising information is transmitted to a first client associated with a first user (step 204). Entrance of the first user, such as an advertisee, or a mobile device associated with the first user to the physical location is detected (step 206). The mobile device associated with the first user preferably includes the first client. The transmission of the advertising information and the detection of the entrance of the first user or the mobile device associated with the first user to the physical location are reported to a second client associated with a second user (step 208), such as the advertiser or other entity involved in the promotion of products, services or events.

In the method 200, advertising information is preferably received with an advertising system 12 from an advertiser client 40 and preferably includes a description of a product, service, event, or happening, hereinafter referred to as a “product”. The indication of a physical location preferably includes a description of an address associated with the product, wherein detecting entrance to the physical location is performed via detecting arrival at the address. The association between a physical location and advertising information is preferably the prerogative of the advertiser or other entity supplying the advertising information and can include a physical location where a product being advertised is sold, a physical location where a service is offered, a physical location where an event being advertised is to occur, or any suitable association.

The advertising information is preferably transmitted as an impression to the first client associated with the first user when the first user is within a static or variable predetermined distance away from the provided physical location. Such impression triggering predetermined distance or data for determining the predetermined distance is preferably specified in information received from the advertiser client 40. Alternatively, the impression triggering predetermined distance can be generated automatically via the advertising system 12 based on one or more of population or building density near the physical target location, geographic features near the physical target location, time of day, and criteria provided by an advertiser via the advertiser client 40. The advertising information is alternatively transmitted without regard to a position of the first client or the first user. Referring to FIG. 2, the advertising information can be transmitted to one client, such as the stationary desktop computer 30₃, associated with a particular user account of a user, and entrance of a different client associated with the particular user account, such as the mobile telephone consumer client 30₁, to a physical location associated with the advertising information can be detected. In such manner, a user's location can be detected via a client which is a different client than the one from which the user received an impression.

In an alternative embodiment of the invention, transmitting the advertising information to a particular client associated with a user includes transmitting information indicating a physical advertisement area at or in proximity to where a particular advertisement is located, which particular client is preferably a mobile device for which location can be determined. The advertisement area can be an outdoor or indoor location where a physical advertisement in the form of a billboard, sign, or other visible or audible, electronic or conventional, display or broadcast, is likely to be observed or heard by the user. A determination of the position of the mobile device is made periodically. If the mobile device is detected to have physically entered the advertisement area and subsequently entered a physical location corresponding to the related advertisement, the detections are preferably reported to another user, such as the advertiser or other entity involved in the procurement of the physical advertisement. Alternatively, detection of physical entrance to the advertisement area can be performed without transmission of an indication of an advertisement area to a particular client. By the foregoing, an indicator of the marketing effectiveness of a physical advertisement, such as a sign or billboard, can be reported in the same manner in which an indicator of the marketing effectiveness of an impression transmitted to a computer client is transmitted. Further, detecting entrance of a mobile device into an advertisement area at or near a physical advertisement can be performed in like manner as described below with reference to detecting entrance to a physical target location associated with the advertising information.

Detecting entrance to a physical location associated with the advertising information by the advertising system 12 can be performed by receiving geographic coordinate measurements corresponding to a current location of the mobile device, and comparing the geographic coordinate measurements with the indication of the physical location to detect the entrance of the mobile device to the physical location associated with the advertising information. Preferably, entrance to the physical location is detected based on detecting a current mobile device location in the form of current geographic coordinates being within a predetermined distance from one or more geographic coordinates of the physical location associated with the advertising information. A threshold is preferably determined around the physical location or a portion of the physical location, and entrance to the physical location is detected based on detecting a current mobile device location being within an area defined by the threshold. Receiving geographic coordinate measurements can include receiving a GPS fix from a mobile device or receiving estimated geographic coordinates generated by the mobile device or other network entity using measurements of signals of base stations in contact with the mobile device. Alternatively, the advertising system 12 can receive measurements of base station signals or other communication signals received or transmitted by the mobile device and determine estimated geographic coordinates corresponding to a current physical location of the mobile device by triangulation or other suitable process.

In the method 200, as opposed to receiving a geographic coordinate or signal measurements indicative of a current location of the mobile device to be used in detecting a mobile device's entrance to the physical location, an indication of entrance to the physical location can be received by the advertising system 12 from a mobile device. In such case, the indication of the physical location is preferably transmitted with the advertising information to the mobile device so that the mobile device can make a determination of when it has entered the physical location. Preferably, a determined threshold area is transmitted to the mobile device, and the indication of entrance to the physical location transmitted by the mobile device is received with advertising system 12 as a report of a breach of the threshold and entrance into the area defined by the threshold. The advertising system 12 also preferably transmits to the mobile device an indication of a predetermined time limit within which the mobile device must transmit an indication of an entrance to the physical location, wherein the indication of an entrance to the physical location will only be received by the advertising system 12 prior to the expiration of the predetermined time limit. Detecting entrance of a mobile device into an advertisement area at or near a physical advertisement associated with the physical location can be performed in like manner as described above.

The advertising information received by the advertising system 12 from each advertising entity via the advertiser client 40 preferably includes target regions for delivery of advertisements. The advertising system 12 preferably delivers impressions to and tracks positions only of advertisees within particular target regions, which regions are defined by neighborhoods, cities, states, countries, or any identifiable area. For example, for multiple physical target locations in a plurality of cites associated with a particular advertising impression, the advertising system 12 delivers impressions when the physical target locations or advertisees are located within one of the plurality of cities within a target region and not others of the plurality of cities. The advertising system 12 preferably further receives from the advertiser client 40 cost rate limits, which include indications of a maximum expense to be incurred by the advertising entity in delivering advertisement impressions, whether costs are incurred and reported on a per advertisement impression or per detection of an entrance into a physical location associated with the advertisement impression. The advertising system 12 preferably refrains from delivery of impressions for a particular advertising entity when costs up to the cost rate limit specified by the entity have been incurred. Indications of a maximum number of impression transmissions or detected can also be received from the advertiser client 40, wherein the advertising system 12 can refrain from delivery of impressions when the maximums have been achieved. The advertising system 12 preferably further receives from the advertiser client 40 indications of demographics of to whom delivery of advertisements are preferred or non-preferred, for example gender, age, and profession preferences. The advertising system 12 preferably refrains from delivery of impressions to advertisees indicated as non-preferred, or alternatively, only transmits impressions to advertisees indicated as preferred.

The advertising system 12 can transmit the advertising information with machine readable coding such that entrance to the physical location of the user or mobile device associated with the user can be detected when the machine readable coding is presented at the physical location. The machine readable coding can enable the production of an electronic or paper coupon electronically redeemable at the physical location associated with the advertising information. Preferred machine readable coding includes but is not limited to data for producing a visible barcode and data for producing a signal output on a mobile device, which visible barcode, signal output or other machine readable coding can be read by a sensor system, such as the advertising target location system 32, at the physical location associated with the advertising information. In such case, transmitting the advertising information to the first client preferably comprises transmitting the advertising information to the mobile device associated with the first user, and the machine readable coding is presented via the mobile device to the sensor system at the physical location associated with the advertising information. The user of the mobile device can place the mobile device in proximity of a sensor at the physical location to permit the sensor to read the machine readable coding as displayed by the mobile device or as signal data transmitted by the mobile device. Alternatively, the machine readable coding can be transmitted automatically from the mobile device at predetermined intervals or in response to signals received from the sensor system at the physical location based on instructions received from the advertising system 12. Alternatively, a user can print or copy the machine readable coding on paper or other suitable medium to present to the sensor system in the manner of a paper coupon.

Pursuant to the method 200, preferably the advertising system 12 must detect the first user or the associated mobile device entering the physical location within a predetermined time from when the advertising information was transmitted to the first client in order to trigger reporting to the second client the detection of the entrance. The predetermined time is a time limit which can be set by the advertising system 12 or a provider of the advertising information such as the advertiser client 40.

The received indication of a physical location can alternatively include identifying information which can be related to an address or geographic coordinate including but not limited to a store name or product name. Popular stores including national chains and franchises often have many different locations even in the same city. Similarly, consumer products are generally sold in many different shopping establishments. In such case, the advertising system 12 preferably performs a search via a network such as the Internet to determine one or more physical locations where an identified store is located or where an identified product is sold.

In addition to reporting to the second client the transmission of the advertising information to and the detection of the entrance to the physical location of the first user or the mobile device associated with the first user, an indication of a billed item is preferably transmitted to the second client indicating a charge incurred as a result of the detection of the entrance to the physical location and/or the transmission of the advertising information. In such manner, an advertiser can be billed based in whole or in part on whether a user having received a particular advertisement actually visits the physical location associated with the advertisement and/or based in whole or in part on transmission of the advertisement.

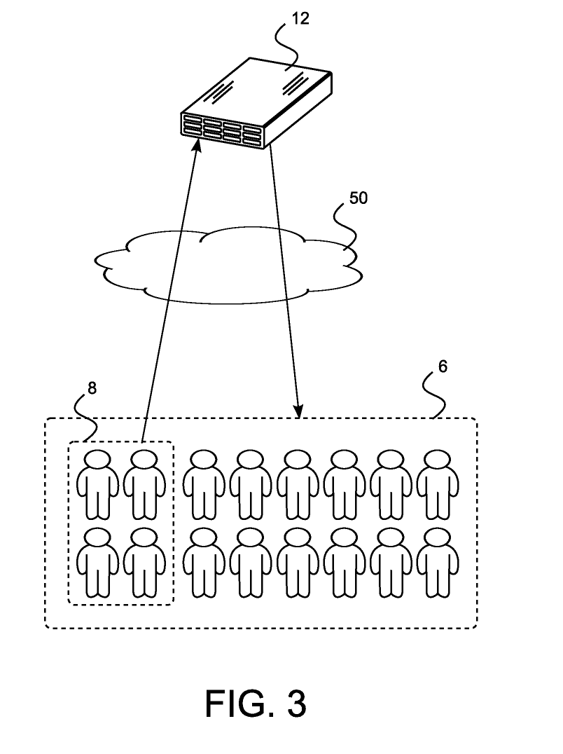

It may be desirable and feasible to transmit advertising impressions or show advertisements to particular population of advertisees, and yet only have the ability to detect the location of a portion of the particular population. Referring to FIG. 3, impressions can be transmitted from the advertising system 12 to a population 6 of advertisees and location can be detected from a portion 8 of the advertisees 6 which correspond to location-trackable-user accounts. For example, the advertising system 12 enables transmission of 1000 impressions to advertisees via consumer clients 30, but only 100 of the advertisees have location-trackable-user accounts with appropriate authorization to enable advertisee location tracking or detection of entrance of an advertisee to a physical target location associated with the impression, or alternatively associated with an advertisement area. If 5 of the advertisees corresponding to location-trackable-user accounts, 5% of the advertisees corresponding to location-trackable-user accounts, are detected as entering the physical target location associated with the impression, the advertising system preferably estimates that 5% of the 1000 advertisees which received the impression enter the physical target location, which are 50 advertisees. Alternatively, other suitable estimation methods can be employed.

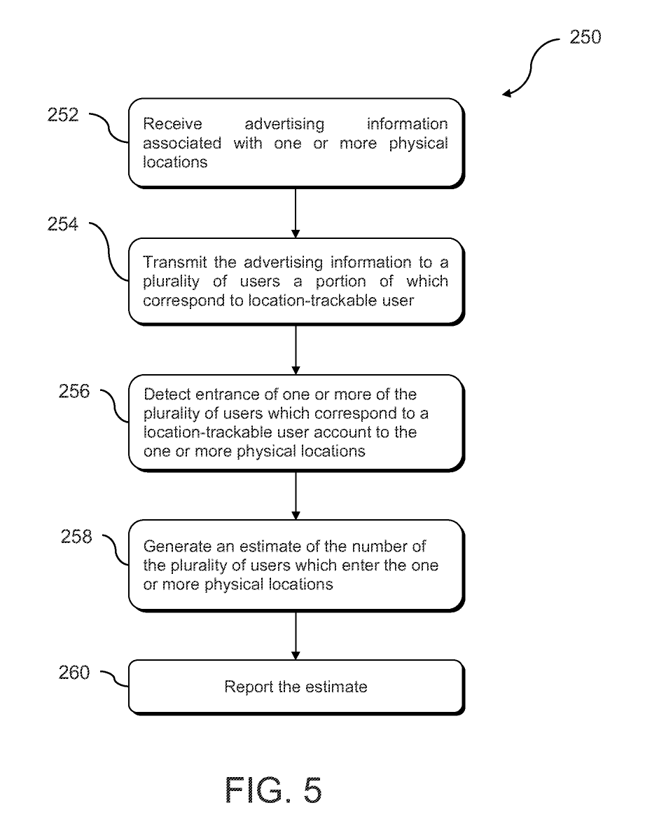

Referring to FIG. 5, a computer-implemented advertising method 250 is shown according to a preferred embodiment of the invention. The method 250 includes receiving advertising information associated with one or more physical locations (step 252). The advertising information is transmitted to a plurality of users, a portion of which correspond to location-trackable user accounts (step 254). Entrance of one or more of the plurality of users which correspond to location-trackable user accounts to the one or more physical locations is detected (step 256). An estimate is generated of the number of the plurality of users which enter the one or more physical locations based on the number of the plurality of users, the number of the plurality of users which correspond to location-trackable user accounts, and the number of the plurality of users which correspond to location-trackable user accounts which are detected as having entered the one or more physical locations (step 258). Preferably the estimate is generated by dividing the number of the plurality of users which correspond to location-trackable user accounts which are detected as having entered the one or more physical locations by the number of the plurality of users which correspond to location-trackable user accounts, and multiplying the result of the division by the total number of the plurality of users. The estimate is reported to an entity (step 260), which entity preferably includes an advertiser or other entity responsible for providing the advertising information.

It would further be desirable to determine what portion of a population of advertisees are likely to visit a particular physical target location regardless of whether they receive an impression or are otherwise exposed to advertising information associated with the particular physical target location. Some advertisees may have visited a particular physical target location one or more times or at predetermined time intervals prior to delivery of an advertising impression or being exposed to a physical advertisement associated with the physical target location. As such, a report to an advertiser or other interested entity should preferably include an accounting of entrances to the physical target location prior to the advertisees' exposure to advertising information. Accordingly, the advertiser or other interested entity can be informed of an actual lift or increase in traffic to a physical target location, which information is more useful in determining the effectiveness of a particular advertising campaign. Historical traffic data, including but not limited to foot traffic and population density information, can be obtained by the advertising server 12 and used to estimate the number of advertisees which would have entered a particular physical target location regardless of whether they received advertisements. Alternatively, particular advertisees to which advertisements are to be transmitted can be location tracked by the advertising server 12 prior to transmission of an impression to or showing an advertisement to the particular advertisees to determine what portion of and with what frequency the particular advertisees entered the particular physical target location prior to being exposed to an advertisement.

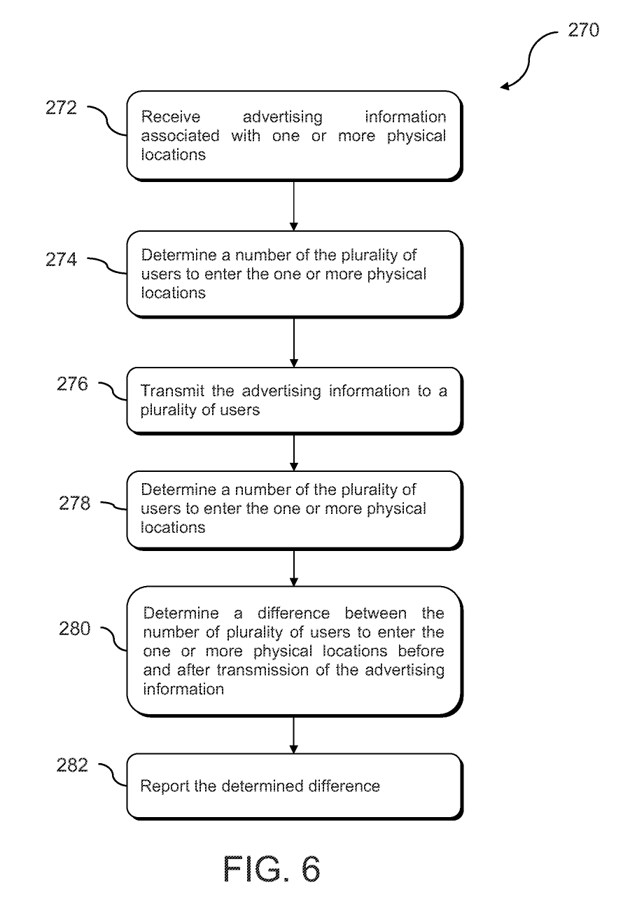

Referring to FIG. 6, a computer-implemented advertising method 270 is shown according to a preferred embodiment of the invention. The method includes receiving advertising information associated with one or more physical locations (step 272). A number of the plurality of users to enter the one or more physical locations is determined (step 274), which step is performed prior to transmission of advertising information to a plurality of users. The advertising information is transmitted to a plurality of users (step 276), and a number of the plurality of users to enter the one or more physical locations is determined after transmission of the advertising information (step 278). A difference between the number of plurality of users to enter the one or more physical locations before transmission of the advertising information and after transmission of the advertising information is determined (step 280). The determined difference is reported to an entity (step 282), which entity preferably includes an advertiser or other entity responsible for providing the advertising information.

Charges to an advertiser in traditional internet market campaigns are often incurred based on whether an internet user selects or clicks on a particular advertisement linking to a product or service description or an advertiser's webpage. Parties with no genuine interest in an advertiser's products or services, such as an advertiser's competitors, may select or click on the online advertisement for the sole purpose of increasing the advertiser's cost, for example to achieve a competitive edge against the advertiser, or to make direct financial gain. Such activity is termed click fraud. To avoid an analogous type of activity corresponding to parties entering or reporting entrance to a physical target location for the sole purpose of making money or generating costs for an advertiser or other entity authorizing delivery of advertisements via the advertising server 12, the advertising server 12 is preferably configured to determine suspicious travel patterns or activity of advertisees. The above-described system and methods may produce a financial incentive for unscrupulous parties to inflate detected entrances to physical target locations by faking location data or performing non-sincere visits to the physical target locations. In one manner of determining whether a detected entrance to a physical target location is suspicious, it can be determined when one or more particular users or mobile devices exceed a predetermined number of detected entrances to a particular physical target location, which particular users are excluded from the determination of detected entrances. In another manner of determining whether a detected entrance to a physical target location is suspicious, it can be determined when a group of particular users or mobile devices are detected as travelling to a particular location along the same route or at the same time, which particular users are excluded from the determination of detected entrances. In another manner of determining whether a detected entrance to a physical target location is suspicious, it can be determined whether other incentives corresponding to a particular physical target location are provided by unscrupulous parties for the purpose of drawing in particular users for reasons unrelated to the particular users' exposure to an impression or advertisement according to the preferred embodiments of the invention, which situation can be factored in reporting detected entrances.

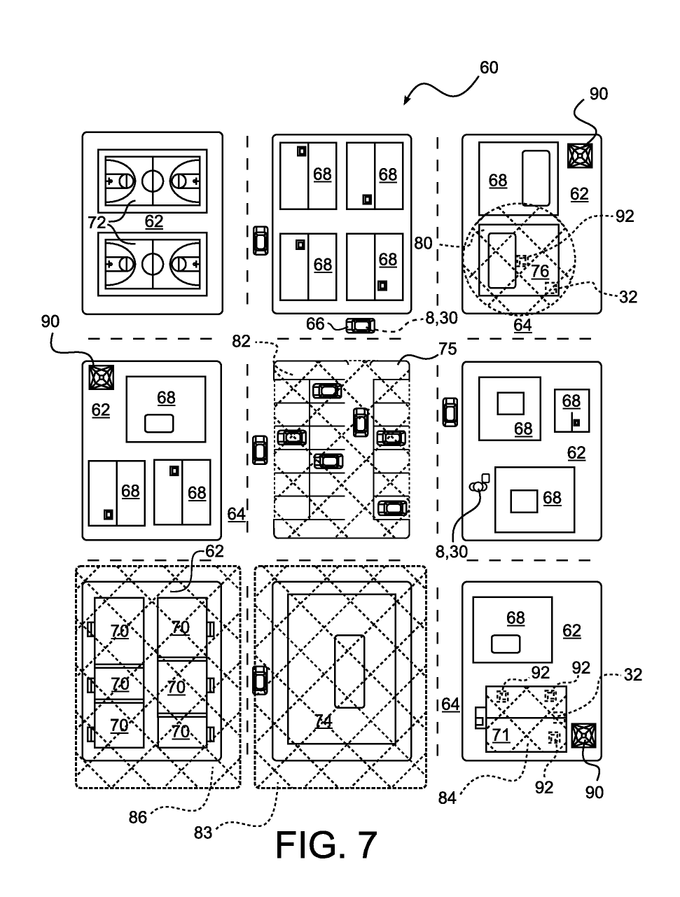

Referring to FIG. 7, a plan view is shown of an example city streetscape 60 in which the advertising system 12 performs an example implementation of a method according to a preferred embodiment of the invention. The streetscape 60 includes city blocks 62 separated by streets 64 permitting travel of vehicles 66. Various building structures are provided on the city blocks 62 including physical locations corresponding to homes 68, retail stores 70, a theater 71, playgrounds 72, a department store 74, and a restaurant 76. Users 8, carrying mobile device consumer clients 30, walk or drive vehicles within the streetscape 60.

When a user 8 carrying a mobile device 30 and meeting predetermined criteria moves within a predetermined distance from a physical location corresponding to particular advertising information, the advertising system 12 transmits the advertising information including an advertisement to the mobile device 30 for display via a user interface to a user 8. The advertising system 12 defines a threshold around a physical location associated with the advertising information. An advertisement promoting the restaurant 76 corresponds to the threshold area 80, which is generated by extending a radius around a geographic coordinate corresponding to the address of the restaurant 76. An advertisement promoting products sold at the retail stores 70 corresponds to the threshold area 86, which is defined by a threshold which is a predetermined distance from a border of the block 62 on which the retail stores 70 are positioned. An advertisement promoting products sold at the department store 74 corresponds to the threshold area 82 and the threshold area 83. The threshold area 82 is defined as an area within a boundary of a parking lot 75 servicing the department store 74. The threshold area 83 is defined by a threshold which is a predetermined distance from a property line of the property on which the department store is built. An advertisement promoting a performance at a theatre 71 corresponds to the threshold area 84, which is defined by a footprint of the theatre 71.

An indication of one or more of the threshold areas 80, 82, 83, 84, 86 corresponding to one or more respective advertisements is sent to the mobile device 30 by the advertising system 12 with the advertising information. When the mobile device 30 detects its location is within a particular threshold area 80, 82, 83, 84, 86 within a predetermined time period after receiving an advertisement, it sends a breach report to the advertising system 12. Transmission of breach reports can be dependent on the user 8 and the mobile device 30 maintaining a presence in a particular threshold area 80, 82, 83, 84, 86 for a particular dwelling period. A user 8 passing through the threshold area 80, 82, 83, 84, 86 quickly, for example in a vehicle 66, for a duration less than the dwelling period would not trigger the transmission of a breach report, since it is preferred that a user 8 be motivated by the particular advertising impression, and not simply using the defined threshold area as a throughway on a particular route. The mobile device 30 preferably detects its location via a GPS fix or via measurements of base station signals from base stations 90. Alternatively, the mobile device 30 or a PDE in communication with the mobile device 30 can transmit the mobile device's detected current geographic coordinates or measurements indicative of its current geographic coordinates to the advertising system 12, and the advertising system 12 can compare the received data with a particular threshold area 80, 82, 83, 84, 86 to determine if a breach has occurred within the predetermined time period for the particular dwelling period. The advertising system 12 thereafter reports the breach or breaches to an advertiser client 40 in the manner described above with reference to FIGS. 1 and 2. Alternatively, the mobile device 30 can emit signals based on instructions received from the advertiser server 12 which identify the mobile device 30 to sensors 92 at locations in the city streetscape 60, which sensors 92 are connected to respective advertising target location systems 32. The sensors 92 define particular threshold areas 80, 84, and the respective advertising target location systems 32 transmit reports of sensor-determined breaches to the advertising system 12.

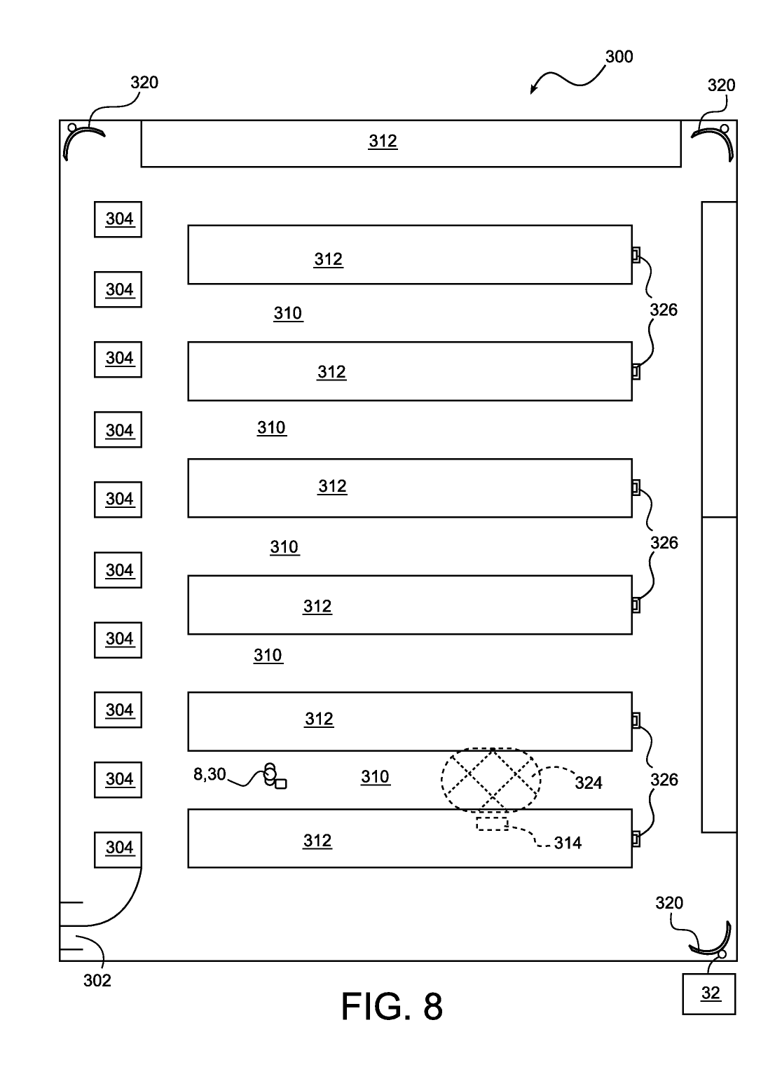

Referring to FIG. 8, a plan view is shown of an example supermarket 300 in which the advertising system 12 of FIG. 1 performs another example implementation of a method according to a preferred embodiment of the invention. The supermarket 300 includes aisles 310 through which a user 8 with a mobile device 30 walks to view and select products on shelves 312. Signal sensors 320 are configured to receive signals from the mobile device 30 to detect its presence in a particular aisle of the supermarket 300. The advertising system 12 transmits advertising information as an impression including an advertisement to the mobile device 30 regarding one or more products within the supermarket 300, which impression is displayed or otherwise related to the user 8 via a user interface on the mobile device 30. The advertising system 12 defines a threshold around one or more physical locations within the supermarket 300 in proximity to the advertised product or products.

An advertisement promoting a product 314 corresponds to the threshold area 324, within an aisle 310. An indication of the threshold area 324 defining the coordinates of the threshold area 324 is sent to the mobile device 30 with the advertising information by the advertising system 12. When the mobile device 30 detects its location is within the defined threshold area 324 within a predetermined time period and for a duration equal to a predetermined dwelling period after receiving an associated advertisement, it sends a breach report to the advertising system 12. The mobile device 30 can detect its location via a GPS fix or via measurements of base station signals from base stations external to the supermarket 300. Alternatively, the mobile device 30 can transmit its detected current geographic coordinates or measurements indicative of current geographic coordinates to the advertising system 12, and the advertising system 12 can compare the received data with the location of the particular threshold area 324 to determine if a breach has occurred. The advertising system 12 thereafter reports the breach, for example in a monthly ad campaign report, to an advertiser client 40 in the manner described above with reference to FIGS. 1 and 2. In indoor environments, it may be difficult or impossible to determine location via GPS or base station signals. Accordingly, the mobile device 30 can emit signals which identify it to sensors 320, within the supermarket 300, connected to an advertising target location system 32, which sensors 320 can define the threshold area 324, for example via triangualation, and which advertising target location system 32 transmits a report of a sensor-determined breach to the advertising system 12. Sensors 320 can alternatively function as base stations permitting location to be determined by the mobile device 30, the advertising system 12 or other position determining entity (“PDE”) in a telecommunication network.

Alternatively, proximity sensing devices 326 in communication with the advertising target location system 32 can be provided at various locations within the supermarket 300. In the case where the advertisement is transmitted with machine readable coding, visual, sound or signal output enabled by such machine readable coding can be read by the proximity sensing devices 326. The user 8 can place the mobile device 30 in proximity to the particular sensing device 326 to permit the device 326 to read the machine readable coding as a display of the mobile device 30, signal data transmitted by the mobile device 30, or other output emitted by the mobile device 30. Alternatively, a user can print the machine readable coding on paper or other suitable medium to present to the proximity sensing device 326 in the manner of a coupon. Alternatively, the machine readable coding can be transmitted to the sensors 320 automatically from the mobile device 30 at predetermined intervals or in response to signals received from the sensors 320 via a suitable signal protocol based on instructions received with the advertisement.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A computer-implemented location based advertising method comprising:
receiving advertising information and an indication of a physical location associated with the advertising information;
transmitting the advertising information to a first client associated with a first user;
detecting entrance of at least one of the first user and a mobile device associated with the first user to the physical location; and
reporting to a second client associated with a second user the transmission of the advertising information and the detection of the entrance of the at least one of the first user and the mobile device associated with the first user to the physical location.

2. The computer-implemented location based advertising method of claim 1, further comprising:
receiving the indication of a physical location with a description of an address; and
detecting arrival at the address.

3. The computer-implemented location based advertising method of claim 1, further comprising:
receiving the advertising information with a description of a product;
receiving the indication of the physical location as an indication of a physical location where the described product is sold; and
detecting entrance to the physical location including the described product.

4. The computer-implemented location based advertising method of claim 1, wherein transmitting the advertising information to the first client comprises transmitting an impression to the mobile device associated with the first user.

5. The computer-implemented location based advertising method of claim 1, further comprising:
receiving geographic coordinate measurements corresponding to a current location of the mobile device; and
comparing the geographic coordinate measurements with the indication of the physical location to detect the entrance of the mobile device to the physical location.

6. The computer-implemented location based advertising method of claim 1, further comprising:
receiving a GPS fix from the mobile device corresponding to a current location of the mobile device; and
comparing the GPS fix with the indication of the physical location to detect the entrance of the mobile device to the physical location.

7. The computer-implemented location based advertising method of claim 1, further comprising:
receiving measurements of base station signals of at least one base station received by the mobile device; and
comparing the measurements of the base station signals with the indication of the physical location to detect the entrance of the mobile device to the physical location.

8. The computer-implemented location based advertising method of claim 1, further comprising:
receiving measurements of base station signals received by the mobile device from a plurality of base stations;
triangulating the current location of the mobile device based on the measurements of base station signals; and
comparing the triangulated current location of the mobile device with the indication of the physical location to detect the entrance to the physical location of the mobile device.

9. The computer-implemented location based advertising method of claim 1, further comprising:
receiving the indication of the physical location as including an address; and
detecting entrance to the physical location based on detecting the mobile device within a predetermined distance from the address.

10. The computer-implemented location based advertising method of claim 1, further comprising:
receiving the indication of the physical location as including an indication of a product;
performing a search via a network to determine at least one physical location where the product is sold; and
detecting entrance of the mobile device to the physical location based on detecting an entrance to the at least one physical location where the product is sold.

11. The computer-implemented location based advertising method of claim 1, further comprising:
receiving the indication of the physical location as including an indication of a store name;
performing a search via a network to determine at least one physical location of the store; and
detecting entrance to the physical location based on detecting an entrance to the at least one physical location of the store.

12. The computer-implemented location based advertising method of claim 11, further comprising detecting entrance to the at least one physical location of the store based on detecting the mobile device within a predetermined distance from the at least one physical location.

13. The computer-implemented location based advertising method of claim 1, further comprising reporting to the second client associated with the second user the transmission of the advertising information and the detection of the entrance into the physical location in response to the at least one of the first user and the mobile device associated with the first user entering the physical location within a predetermined time from when the advertising information was transmitted to the first client.

14. The computer-implemented location based advertising method of claim 1, further comprising:
transmitting the advertising information with machine readable coding; and
detecting entrance to the physical location of the at least one of the first user and the mobile device associated with the first user by detecting the machine readable coding as presented by the first user.

15. The computer-implemented location based advertising method of claim 14, wherein transmitting the advertising information to the first client comprises transmitting the advertising information to the mobile device associated with the first user, the method further comprising detecting the machine readable coding as transmitted by the mobile device.

16. The computer-implemented location based advertising method of claim 1, further comprising transmitting an indication of a billed item to the second client in response to the detection of the entrance into the physical location of the at least one of the first user and the mobile device associated with the first user.

17. The computer-implemented location based advertising method of claim 1, wherein the first client is the mobile device, the method further comprising:
transmitting the indication of the physical location to the mobile device; and
receiving from the mobile device an indication of an entrance to the physical location.

18. The computer-implemented location based advertising method of claim 17, further comprising determining a threshold around at least a portion of the physical location, wherein transmitting the indication of the physical location comprises transmitting an indication of the threshold, and wherein receiving the indication of the entrance to the physical location comprises receiving the indication an entrance to an area defined by the threshold.

19. The computer-implemented location based advertising method of claim 1, wherein the first client is the mobile device, the method further comprising:
transmitting the indication of the physical location to the mobile device;
transmitting to the mobile device an indication of a predetermined time limit within which the mobile device can transmit an indication of an entrance to the physical location; and
receiving from the mobile device an indication of an entrance to the physical location prior to an expiration of the predetermined time limit.

20. The computer-implemented location based advertising method of claim 19, further comprising determining a threshold defined by at least one predetermined distance from the physical location around at least a portion of the physical location, wherein transmitting the indication of the physical location comprises transmitting an indication of the threshold, and wherein receiving the indication of the entrance to the physical location comprises receiving an indication of an entrance to an area defined by the threshold.

21. The computer-implemented location based advertising method of claim 1, further comprising receiving an indication of the entrance to the physical location detected by a sensor positioned at the physical location.

22. The computer-implemented location based advertising method of claim 1, wherein transmitting the advertising information to a first client comprises transmitting the advertising information to the mobile device associated with the first user, the method further comprising transmitting the advertising information to the mobile device in response to the mobile device moving within a predetermined distance of the physical location.

23. The computer-implemented location based advertising method of claim 1, wherein transmitting the advertising information to a first client comprises transmitting the advertising information to the mobile device associated with the first user, the method further comprising:
detecting a period of time the mobile device dwells in the physical location; and
reporting to the second client the entrance to the physical location of the mobile device in response to the dwelling period exceeding a predetermined time period.

24. The computer-implemented location based advertising method of claim 1, further comprising:
receiving a cost rate limit;
reporting indications of costs incurred to the second client based on at least one of the transmission of the impression and the detection of the entrance to the physical location;
transmitting the advertising information to a plurality of clients including the first client associated with a plurality of users until the cost rate limit is substantially met;
detecting entrance to the physical location of at least one of the plurality of users and respective mobile devices associated with the plurality of users; and
reporting to the second client the transmission of the advertising information and the detection of the entrance to the physical location of the at least one of the plurality of users and the respective mobile devices.

25. The computer-implemented location based advertising method of claim 1, further comprising:
receiving an indication of at least one of a maximum number of transmissions of the advertising information and a maximum number of detections of entrance to be made during a particular time period;
transmitting the advertising information to a plurality of clients including the first client associated with a plurality of users at least one of until the maximum number of transmissions and the maximum number of detections of entrance is achieved;
detecting entrance to the physical location of at least one of the plurality of users and respective mobile devices associated with the plurality of users; and
reporting to the second client the transmission of the advertising information and the detection of the entrance to the physical location of the at least one of the plurality of users and the respective mobile devices.

26. The computer-implemented location based advertising method of claim 1, further comprising:
receiving the indication of the physical location as an indication of a plurality of physical locations;
detecting entrance of at least one of the first user and the mobile device associated with the first user to at least one of the plurality of physical locations; and
reporting to the second client associated with the second user the transmission of the advertising information and the detection of the entrance of the at least one of the first user and the mobile device associated with the first user to the at least one of the plurality of physical locations.

27. A location based advertising system comprising at least one computing device including at least one memory comprising instructions operable to enable the computing device to perform a procedure comprising:
transmitting advertising information as an impression to a mobile device associated with a first user;
detecting entrance of the mobile device to a physical location associated with the advertising information; and
reporting to a client system associated with a second user the transmission of the advertising information and the detection of the entrance of the mobile device to the physical location.

28. Non-transitory computer-readable media tangibly embodying a program of instructions executable by a computing device to implement a method, the computing device being capable of interfacing with a communications network, the method comprising:
transmitting advertising information as an impression to a mobile device associated with a first user;
detecting entrance of the mobile device to a physical location associated with the advertising information associated; and
reporting to a client system associated with a second user the transmission of the advertising information and the detection of the entrance of the mobile device to the physical location.

29. A computer-implemented advertising method comprising:
receiving advertising information associated with at least one physical location;
transmitting the advertising information to a plurality of users, a portion of which correspond to location-trackable user accounts;
detecting entrance of at least one of the plurality of users which corresponds to a location-trackable user account to the at least one physical location;
generating an estimate of the number of the plurality of users which enter the at least one physical location based on:
the number of the plurality of users;
the number of the plurality of users which correspond to location-trackable user accounts; and
the number of the plurality of users which correspond to location-trackable user accounts which are detected as having entered the at least one physical location; and
reporting the estimate to an entity.

30. The computer-implemented advertising method of claim 29, further comprising generating the estimate by:
dividing the number of the plurality of users which correspond to location-trackable user accounts which are detected as having entered the at least one physical location by the number of the plurality of users which correspond to location-trackable user accounts; and
multiplying the result of the division by the number of the plurality of users.

31. A computer-implemented advertising method comprising:
receiving advertising information associated with at least one physical location;
transmitting the advertising information to a plurality of users;
determining a number of the plurality of users to enter the at least one physical location after transmitting the advertising information to the plurality of users; and
reporting to an entity the determination of the number of the plurality of users to enter the at least one physical location after transmitting the advertising information.

32. The computer-implemented advertising method of claim 31, further comprising:
determining a number of the plurality of users to enter the at least one physical location prior to transmitting the advertising information to the plurality of users;
determining a difference between the number of the plurality of users to enter the at least one physical location after transmitting the advertising information and the number of the plurality of users to enter the at least one physical location prior to transmitting the advertising information; and
reporting to the entity the determined difference.

33. The computer-implemented advertising method of claim 31, further comprising:
receiving at least one of population density information and foot traffic information in proximity to the at least one physical location;
estimating a number of the plurality of users to enter the at least one physical location prior to transmitting the advertising information to the plurality of users based on the at least one of the population density information and the foot traffic information; and
reporting to the entity the difference between the determination of the number of the plurality of users to enter the at least one physical location after transmitting the advertising information and the number of the plurality of users to enter the at least one physical location prior to transmitting the advertising information.

34. The computer-implemented advertising method of claim 31, further comprising determining the number of the plurality of users to enter the at least one physical location by detecting user entrance based on at least one of:
a GPS fix of a mobile device associated with a user;
a measurement of signals received by the mobile device from a base station; and
a measurement of signals sent by the mobile device to a base station.

35. The computer-implemented advertising method of claim 31, further comprising receiving an authorization to determine the location of the plurality of users respectively from the plurality of users.

36. The computer-implemented advertising method of claim 31, further comprising:
transmitting the advertising information as a plurality of impressions respectively associated with a plurality of physical locations;
determining when at least one particular user of the plurality of users exceeds a predetermined number of entrances to the plurality of physical locations; and
reporting to an entity the determination of the number of the plurality of users to enter the at least one physical location excluding the at least one particular user.

37. The computer-implemented advertising method of claim 31, further comprising:
transmitting the advertising information as a plurality of impressions respectively associated with a plurality of physical locations;
determining when at least one particular user of the plurality of users follows a predetermined travel pattern; and
reporting to an entity the determination of the number of the plurality of users to enter the at least one physical location excluding the at least one particular user following the predetermined travel pattern.

38. The computer-implemented advertising method of claim 31, further comprising:
transmitting the advertising information as a plurality of impressions respectively associated with a plurality of physical locations;
determining when particular ones of the plurality of users travel substantially together; and
reporting to an entity the determination of the number of the plurality of users to enter the at least one physical location excluding the particular ones of the plurality of users which travel substantially together.

39. A computer-implemented location based advertising method comprising:
receiving advertising information comprising an indication of a physical advertisement area, wherein the physical advertisement area comprises a physical advertisement to be exposed to a user;
receiving an indication of a physical location associated with the advertisement area;
detecting entrance of at least one of a first user and a mobile device associated with the first user to the advertisement area;
detecting entrance of at least one of the first user and the mobile device associated with the first user to the physical location; and
reporting to a second user the detection of the entrance of the at least one of the first user and the mobile device associated with the first user to the advertisement area and the physical location.
